(19) United States
(12) Patent Application Publication
(10) Pub. No.: US 2013/0138853 A1
(43) Pub. Date: May 30, 2013

(54) ADJUSTMENT DEVICE AND METHOD FOR ADJUSTING INTERFACE EXPANDER

(71) Applicant: CHIH-HUANG WU, Tu-Cheng (TW)

(72) Inventor: CHIH-HUANG WU, Tu-Cheng (TW)

(73) Assignee: HON HAI PRECISION INDUSTRY CO., LTD., Tu-Cheng (TW)

(21) Appl. No.: 13/545,840

(22) Filed: Jul. 10, 2012

(30) Foreign Application Priority Data
Nov. 25, 2011 (TW) 100143458

(51) Int. Cl. G06F 13/00

(52) U.S. Cl. 710/300

(57) ABSTRACT

An adjustment device for automatically adjusting an interface expander with a signal port and a firmware is provided. The adjustment device includes a MCU connected to the signal port, a serial port, and an analysis unit connected to the MCU via the serial port. The MCU receives signals output by the signal port and convert the received signals to serial digital signals, and transmits the serial digital signals to the analysis unit. The analysis unit stores a digital signal reflecting a signal standard of the interface expander, and compare the received serial digital signals with the stored digital signal to determine whether the received serial digital signals accord with the stored digital signal, and produces an adjustment signal to the firmware to adjust a register value of the firmware when determining the received serial digital signals do not accord with the stored digital signal.

### BACKGROUND

1. Technical Field

The present disclosure relates to adjustment devices, particularly, to an adjustment device and a method for adjusting an interface expander.

2. Description of Related Art

Interface expanders, such as Serial attached SCSI expanders (SAS Expanders) are widely used in computer industry. Usually, to determine if the SAS Expander satisfies requirements, the signals transmitted by the SAS Expander are tested to satisfy a relevant signal standard. When the SAS Expander is being used in a computer, if the signals transmitted by the SAS Expanders do not satisfy the signal standard, then there is need to adjust the signals output by the SAS Expanders. However, usual SAS Expanders need to be adjusted manually by an operator, which is inconvenient.

An adjustment device for adjusting the interface expanders to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an adjustment device for adjusting an interface expander, in accordance with an exemplary embodiment.

FIG. 2 is a circuit diagram of the adjustment device of FIG. 1, in accordance with an exemplary embodiment.

FIG. 3 is schematic diagram of a signal transmitted by the interface expander adjusted by of the adjustment device of FIG. 1, in accordance with an exemplary embodiment.

### DETAILED DESCRIPTION

Embodiments of the present disclosure will be described, with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

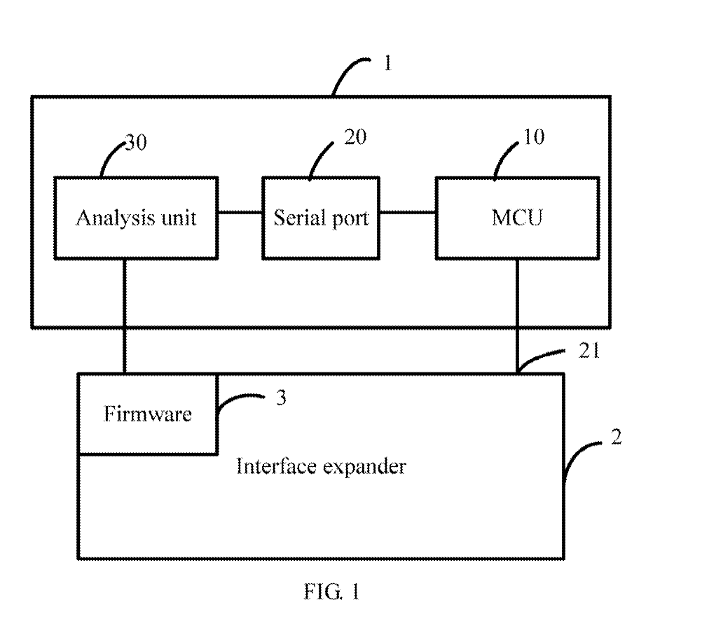

FIG. 1, is an adjustment device 1 for automatically adjusting parameters of an interface expander 2. The interface expander 2 includes a signal port 21 and a firmware 3 storing a register value. The adjustment device 1 adjusts the register value stored in the firmware 3 to adjust signals output by the interface expander 2. In an embodiment, the interface expander 2 can be a serial attached SCSI expander (SAS expander).

The adjustment device 1 includes a micro controller unit (MCU) 10, a serial port 20, and an analysis unit 30. The MCU 10 is connected to the signal port 21 of the interface expander 2, and is used to receive the signals output by the signal port 21 of the interface expander 2 and converts the received signals to serial digital signals. The serial port 20 is connected between the MCU 10 and the analysis unit 30. The analysis unit 30 receives the serial digital signals converted by the MCU 10 via the serial port 20. The analysis unit 30 is also connected to the firmware 3 of the interface expander 2 and stores a digital signal reflecting a signal standard of the interface expander 2. The analysis unit 30 compares the serial digital signals received from the MCU 10 with the digital signal reflecting the signal standard to determine whether the received serial digital signals match with the digital signal reflecting the signal standard. If the analysis unit 30 determines that the received serial digital signals do not match with the digital signal reflecting the signal standard, the analysis unit 30 produces an adjustment signal to the firmware 3 to adjust the register value of the firmware 3. Thus adjusting the signals output by the interface expander 2 to make the signals output by the interface expander 2 satisfies the requirement.

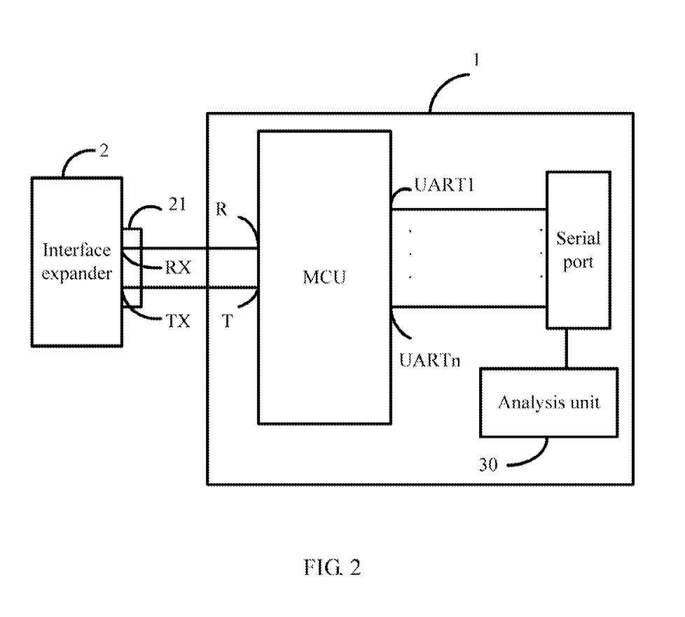

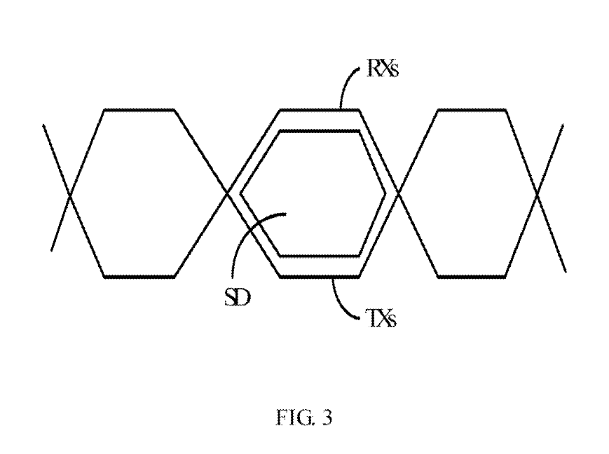

Referring also to FIGS. 2 and 3, in the embodiment, the signal port 21 of the interface expander 2 includes a signal input pin RX and a signal output pin TX, and the MCU 10 includes two signal pins R, X, and a number of serial pins UTRL1˜UTRLn. The signal pins R, X are respectively connected to the signal input pin RX and the signal output pin TX of the signal port 21 of the interface expander 2. The serial pins UTRL1˜UTRLn are respectively connected to pins (not labeled) of the serial port 20.

Usually, the signal input pin RX of the signal port 21 outputs differential signals RXs, and the signal output pin TX of the signal port 21 outputs differential signal TXs. The two differential signals RXs, TXs with positive or negative voltage alternately and constitute an eye pattern with a number of hexagons. As shown in FIG. 3, the digital signal reflecting the signal standard is expressed as a standard hexagon SD. As common, if a size of the hexagons of the eye pattern constituted by the two differential signals RXs, TXs is larger than a size of the standard hexagon, then the signals (the differential signals RXs, TXs) transmitted by the signal port 21 satisfies the requirement.

The MCU 10 receives the differential signals RXs, TXs transmitted by the signal input pin RX of the signal port 21 and the signal output pin TX of the signal port 21 of the interface expander 2 and converts the differential signals RXs, TXs to the serial digital signals. The analysis unit 30 determines whether there is at least one intersection of the standard hexagon SD and the differential signals RXs, TXs by comparing the serial digital signals received from the MCU 10 with the digital signal reflecting the signal standard SD. In detail, the analysis unit 30 compares the serial digital signals received from the MCU 10 with the digital signal reflecting the signal standard to judge whether there are two digital signals with the same value at the same time. If there are two digital signals with the same value at the same time, the analysis unit 30 determines that there is at least one intersection of the standard hexagon SD and the differential signals RXs, TXs.

The analysis unit 30 also determines if the received serial digital signals do not match with the digital signal reflecting the signal standard if it determines that there is at least one intersection of the standard hexagon SD and the differential signals RXs, TXs. As shown in FIG. 3, if there are two digital signals with the same value at the same time. Then the hexagons of the eye pattern constituted by the two differential signals RXs, TXs overlap the standard hexagon SD. Creating at least one intersection of the standard hexagon SD and the differential signals RXs, TXs, then the signals transmitted by the signal port 21 do not satisfy the requirement.

In one embodiment, the register value consists of a number of bits, such as 16 bits, and the register value corresponds to one period of the differential signals RXs, TXs. Typically, the value of each bit of the register value is used to represent amplitudes of the signals of the differential signals RXs, TXs. For example, if the value of one bit is “1”, the signals of the signal input pin RX and the signal output pin TX are respectively at the positive maximum amplitude or negative maximum amplitude, if the value of one bit is “0”, the signals of the signal input pin RX and the signal output pin TX are at zero. Furthermore, the duration of the maximum amplitude of the signals of the signal input pin RX and the signal output pin TX is determined by the number of the bits whose value is “1” of the register value.

If the analysis unit 30 determines that the received serial digital signals do not accord with the digital signal reflecting the signal standard, the analysis unit 30 produces an adjustment signal to the firmware 3 to change the value of at least one bit from “0” to “1” to increase the number of the bits whose value is “1”, thus enlarging the hexagon constituted by the two differential signals and making the signals transmitted by the signal port 21 of the interface expander 2 satisfy the requirement. If the analysis unit 30 determines the received serial digital signals accord with the digital signal reflecting the signal standard, the analysis unit 30 does not produce the adjustment signal to the firmware 3.

In one embodiment, the analysis unit 30 can be a microprocessor, and the adjustment device 1 is set in a same electronic device equipping the interface expander 2.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An adjustment device, configured to automatically adjust signals output by an interface expander, wherein the interface expander comprises a firmware and a signal port for transmitting the signals, the adjustment device comprising:
a micro controller unit (MCU), connected to the signal port of the interface expander, configured to receive the signals output by the signal port and convert the received signals to serial digital signals;
a serial port;
an analysis unit storing a digital signal reflecting a signal standard of the interface expander, wherein the analysis unit is electrically connected to the MCU via the serial port and is connected to the firmware; the analysis unit is configured to receive the serial digital signals from the MCU via the serial port, to compare the serial digital signals received from the MCU with the digital signal reflecting the signal standard to determine whether the received serial digital signals match with the digital signal reflecting the signal standard, and to produce an adjustment signal to the firmware to adjust a register value of the firmware when determining that the received serial digital signals do not match with the digital signal reflecting the signal standard; thus adjusting the signals transmitted by the signal port of the interface expander to make the signals transmitted by the signal port satisfy a requirement.

2. The adjustment device according to claim 1, wherein the signal port of the interface expander comprises a signal input pin and a signal output pin.

3. The adjustment device according to claim 1, wherein the MCU comprises two signal pins and several serial pins, the two signal pins are respectively connected to the signal input pin and the signal output pin of the signal port, the serial pins are respectively connected to pins of the serial port

4. The adjustment device according to claim 3, wherein the signal transmitted by the signal input pin and the signal output pin the serial port of the interface expander both are differential signals, and the differential signals transmitted by the signal input pin and the signal output pin with positive or negative voltage alternately and constitute an eye pattern with a number of hexagons.

5. The adjustment device according to claim 4, wherein the digital signal reflecting the signal standard is expressed as a standard hexagon, the analysis unit is configured to determine that the received serial digital signals do not match with the digital signal reflecting the signal standard if determining there is at least one intersection of the standard hexagon and the two differential signals.

6. The adjustment device according to claim 5, wherein the register value comprises a plurality of bits, the analysis unit is further configured to produce an adjustment signal to the firmware to change the value of at lease one bit of the register value from “0” to “1”, if the received serial digital signals do not match with the digital signal reflecting the signal standard, thus enlarging a hexagon constituted by the two differential signals and making the signals transmitted by the signal port of the interface expander satisfy the requirement.

7. The adjustment device according to claim 1, wherein the analysis unit is a microprocessor.

8. The adjustment device according to claim 1, wherein the adjustment device is set in an electronic device equipping the interface expander.

9. The adjustment device according to claim 1, wherein the interface expander is a serial attached SCSI expanders.

10. A method for automatically adjust signals output by an interface expander, the interface expander comprises a firmware and a signal port for transmitting signals, the method comprising:
receiving the signals output by a signal port of the interface expander and convert the received signals to serial digital signals via a MCU;
receiving the serial digital signals from the MCU via an analysis unit;
comparing the serial digital signals with a digital signal reflecting a signal standard to determine whether the received serial digital signals match with the digital signal reflecting the signal standard via the analysis unit;
producing an adjustment signal to the firmware to adjust a register value of the firmware when determining that the received serial digital signals do not match with the digital signal reflecting the signal standard via the analysis unit.

11. The method according to claim 10, wherein the signal transmitted by the serial port of the interface expander both are two differential signals, and the two differential signals with positive or negative voltage alternately and constitute an eye pattern, the digital signal reflecting the signal standard is expressed as a standard hexagon;
the step “comparing the serial digital signals with a digital signal reflecting a signal standard to determine whether the received serial digital signals match with the digital signal reflecting the signal standard via the analysis unit” comprises:
comparing the serial digital signals received from the MCU with the digital signal reflecting the signal standard to judge whether there is at least one intersection of the standard hexagon and the two differential signals; and
determining the received serial digital signals do not match with the digital signal reflecting the signal standard if there is the at least one intersection of the standard hexagon and the two differential signals.

12. The method according to claim 10, wherein, the step “producing an adjustment signal to the firmware to adjust a register value of the firmware” comprises:
producing an adjustment signal to the firmware to change a value of at lease one bit of the register value from “0” to “1” if the received serial digital signals do not match with the digital signal reflecting the signal standard.
